(19) United States
(12) Patent Application Publication
(10) Pub. No.: US 2023/0049833 A1
(43) Pub. Date: Feb. 16, 2023

(54) INKJET PRINTING APPARATUS

(71) Applicant: MIMAKI ENGINEERING CO., LTD., Nagano (JP)

(72) Inventor: Kazuki Ohara, Nagano (JP)

(73) Assignee: MIMAKI ENGINEERING CO., LTD., Nagano (JP)

(21) Appl. No.: 17/791,901

(22) PCT Filed: Dec. 28, 2020
(86) PCT No.: PCT/JP2020/049061

§ 371 Date: Jul. 10, 2022

(30) Foreign Application Priority Data
Jan. 12, 2020 (JP) 2020-003292

(51) Int. Cl. B41J 11/00; B41M 5/00

(52) U.S. Cl. CPC B41J 11/00214; B41J 11/0022; B41M 5/0064; B41M 5/0047

(57) ABSTRACT

An inkjet printing apparatus 1 includes an ink-jet head 23 that ejects UV curable ink to a medium M, an irradiation lamp 25 that irradiates the UV curable ink ejected to the medium M with ultraviolet rays, and a heater 37 that heats the UV curable ink after the ultraviolet ray irradiation by the irradiation lamp 25 and thereby stabilizes color fixation of the UV curable ink. The UV curable ink after the ultraviolet ray irradiation is heated at least at 35° C.

### TECHNICAL FIELD

The present invention relates to an inkjet printing apparatus.

### BACKGROUND ART

Patent Literature 1 discloses an inkjet printer using UV curable ink.

### CITATION LIST

### Patent Literature

Patent Literature 1: Japanese Patent Application Laid-open No. 2005-96277

UV curable ink is solidified by irradiation with ultraviolet rays in a short time. Therefore, information such as images and letters (hereafter referred to as images) can be suitably printed on a variety of media.

### SUMMARY OF INVENTION

### Technical Problem

It has been known that when an image is printed using UV curable ink, the color tone of the image immediately after printing deviates from the target color tone, but the color tone of the image changes over time and is eventually settled to the target color tone.

Therefore, color matching in calibration at correcting printed matters or at the start of printing, emulation for printing with different inkjet printers, and the like needs to wait until the color tone of the image changes over time and is settled. However, there is a need that it is desired to correct the printed matter as early as possible after printing. In view of this, it has been requested to settle the color tone of the image in a shorter time.

### Solutions to the Problems

An inkjet printing apparatus according to an aspect of the present invention includes: an ink-jet head that ejects UV curable ink to a medium; an ultraviolet ray irradiation unit that irradiates the UV curable ink ejected to the medium with ultraviolet rays; and a heating unit that heats the UV curable ink after the ultraviolet ray irradiation by the ultraviolet ray irradiation unit and thereby stabilizes color fixation of the UV curable ink.

The present inventor has found that when the UV curable ink is heated after the ultraviolet ray irradiation, the color tone of the printed image is settled to the target color tone in a very short time compared to the case without heating.

The inkjet printing apparatus that uses the UV curable ink does not require a heater, unlike other inkjet printing apparatuses that use water-based or solvent-based ink. By providing a heating unit on purpose to heat the UV curable ink after the ultraviolet ray irradiation, the color fixation of the UV curable ink can be stabilized in a shorter time.

Thus, the color tone of the image can be settled in a shorter time.

In a second aspect of the present invention, the heating unit is provided downstream of a position irradiated with the ultraviolet rays in a conveying direction of the medium.

The UV curable ink turns yellow immediately after the ultraviolet ray irradiation, resulting in a yellowish color tone, and thereafter the yellowish color decreases over time and the color settles to the original color.

Here, the dot gain of the ink droplet that lands on the medium is fixed by the ultraviolet ray irradiation and changes before the ultraviolet ray irradiation. Therefore, heating the UV curable ink before the ultraviolet ray irradiation may affect the dot gain.

With the structure as described above, the heating unit is disposed at a position where the UV curable ink can be properly heated after the ultraviolet ray irradiation.

Thus, the heating will not have any influence on the dot gain of the ink droplet that has landed on the medium and accordingly, the improvement of the printing quality can be expected.

In a third aspect of the present invention, the heating unit is configured to heat the UV curable ink so that the UV curable ink stops changing in hue at a position downstream of the heating unit in the conveying direction of the medium and thereby stabilizes the color fixation of the UV curable ink.

The UV curable ink turns yellow immediately after the ultraviolet ray irradiation, resulting in a yellowish color tone. When the yellowed UV curable ink is heated, the yellowish color tone is reduced and the color tone settles to its original color in a shorter time than when heating is not performed.

Therefore, the heating time of the UV curable ink after the ultraviolet ray irradiation can be optimized by determining the end timing of heating by the heating unit on the basis of the hue change of the UV curable ink after the ultraviolet ray irradiation. Furthermore, the color fixation of the UV curable ink can be stabilized at the downstream position immediately after heating by the heating unit, so that proofreading of printed matters, etc. can be performed at an early stage after printing.

In a fourth aspect of the present invention, the lower limit of heating temperature of the UV curable ink by the heating unit is 35° C.

By setting the heating temperature by the heating unit to 35° C. or higher, the UV curable ink after the ultraviolet ray irradiation can be heated until the UV curable ink stops changing in hue.

This makes it possible to integrate the heating unit into the medium conveyance path of the existing printer apparatus without difficulty.

In other words, the UV curable ink after the ultraviolet ray irradiation can be heated until the UV curable ink stops changing in hue without the necessity of extending the medium conveyance path in order to secure the time for heating the UV curable ink after the ultraviolet ray irradiation. Therefore, there is no need to make the inkjet printing apparatus particularly large.

In a fifth aspect of the present invention, the medium is a medium that makes a contact angle of the UV curable ink less than 55° with respect to the medium at the time of ultraviolet ray irradiation by the ultraviolet ray irradiation unit.

Thus, even in the case of the medium with a contact angle of less than 55°, that is, the medium with the small contact angle of the UV curable ink that has landed thereon, heating the UV curable ink immediately after the ultraviolet ray irradiation can stabilize the color fixation of the UV curable ink in a shorter time and settle down the color tone of the printed image in a shorter time.

In a sixth aspect of the present invention, the medium is PVC or PET.

Even in the case of the medium with the small contact angle of the ink droplet of the UV curable ink that has landed thereon, such as PVC or PET, the color fixation of the UV curable ink can be stabilized in a shorter time and the color tone of the printed image can be settled down in a shorter time.

### Effect of the Invention

According to the present invention, the color tone of printed images can be settled down in a shorter time.

### DESCRIPTION OF THE DRAWINGS

FIG. 1 is a diagram for describing an inkjet printing apparatus.

FIG. 2 is a diagram for describing the inkjet printing apparatus.

FIG. 3 is a diagram for describing a color difference behavior after ultraviolet ray irradiation.

FIG. 4 is a diagram for describing a difference of the color difference behavior after ultraviolet ray irradiation depending on the presence or absence of heating.

FIG. 5 is a diagram for presuming the change of a color tone over time due to the change of initiator radicals over time.

FIG. 6 is a diagram expressing the change over time of a color difference ΔE of UV curable ink.

FIG. 7 is a diagram for describing the relation between the difference in medium and the color difference ΔE.

FIG. 8 is a diagram for describing the relation between the difference in medium and the contact angle of the UV curable ink.

FIG. 9 is a diagram expressing the relation between the presence or absence of heating and the difference in heating temperature, and the change over time of the color difference ΔE.

### DESCRIPTION OF EMBODIMENT

An embodiment of the present invention is hereinafter described.

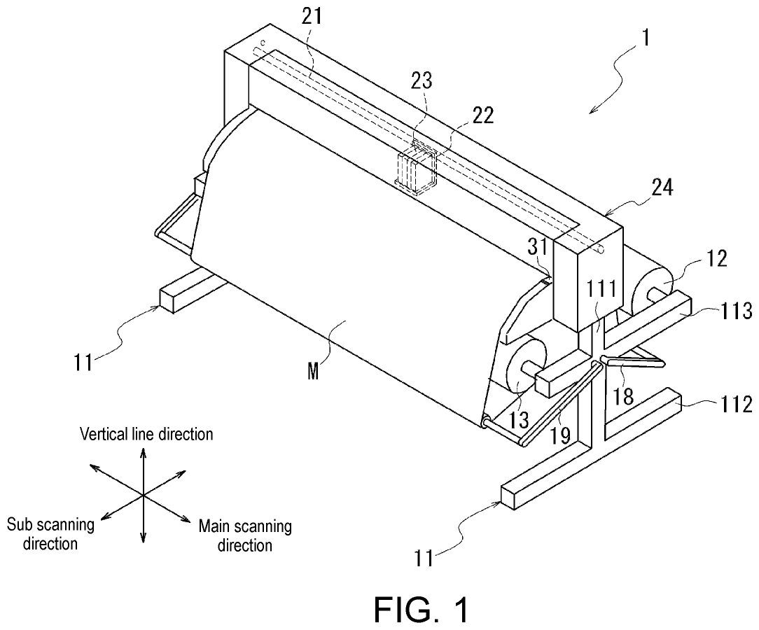

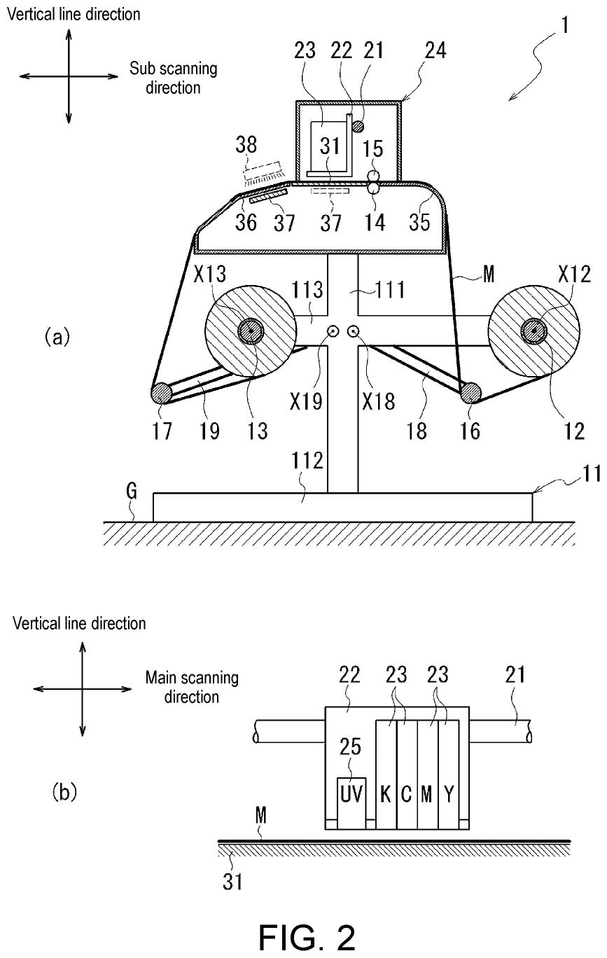

FIG. 1 and FIG. 2 are diagrams for describing an inkjet printing apparatus 1.

FIG. 1 is a perspective view in which the inkjet printing apparatus 1 is viewed obliquely from above. In FIG. 2, (a) is a side cross-sectional view of the inkjet printing apparatus 1. In FIG. 2, (b) is a diagram for describing the arrangement of ink-jet heads 23 in a carriage 22, schematically illustrating the carriage 22 viewed from a sub scanning direction.

As illustrated in FIG. 1, the inkjet printing apparatus 1 has a guide rail 21 provided in a direction along a main scanning direction. In the guide rail 21, the carriage 22 on which the ink-jet heads 23 are mounted is provided movably in a longitudinal direction of the guide rail 21 (main scanning direction).

As illustrated in (b) in FIG. 2, the ink-jet heads 23 are aligned in the main scanning direction in the carriage 22. A plurality of ejection nozzles (not illustrated) are provided on a lower surface of the ink-jet heads 23 on a platen 31 side.

In the carriage 22, an ultraviolet ray irradiation lamp 25 (ultraviolet ray irradiation unit) is provided on at least one side in the main scanning direction.

As illustrated in FIG. 1, the guide rail 21 to which the carriage 22 is provided is housed in a box-shaped case 24. Both sides of the case 24 in the longitudinal direction (main scanning direction) are fixed to the top of columns 111 of support legs 11.

The platen 31 is located on the lower side of the case 24. The platen 31 is provided along the main scanning direction. Both sides of the platen 31 in the longitudinal direction are supported by the columns 111 and 111.

At the bottom of each column 111, a leg part 112 that extends in the front-rear direction (sub scanning direction) of the inkjet printing apparatus 1 is provided. A lower surface of the leg part 112 is placed on an installation surface G of the inkjet printing apparatus 1 (see (a) in FIG. 2). The case 24 of the inkjet printing apparatus 1 is provided horizontally above the installation surface G.

As illustrated in (a) in FIG. 2, an upstream supporting unit 35 is provided behind (in the drawing, on the right side of) the platen 31 in the front-rear direction of the inkjet printing apparatus 1. Ahead of (in the drawing, on the left side of) the platen 31, a downstream supporting unit 36 is provided.

The platen 31 and the upstream supporting unit 35 are provided with a gap therebetween in the front-rear direction of the inkjet printing apparatus 1. Between the platen 31 and the upstream supporting unit 35, a grid roller 14 and a pinch roller 15 are arranged vertically.

In the cross-sectional view, the upstream supporting unit 35 is formed to have an arc-like shape. Below the upstream supporting unit 35, a tension bar 16 supported by a rotation supporting unit 18 is provided.

In the cross-sectional view, the downstream supporting unit 36 is formed to have an arc-like shape. The downstream supporting unit 36 is formed with a smaller radius of curvature than the upstream supporting unit 35. Below the downstream supporting unit 36, a tension bar 17 supported by the rotation supporting unit 19 is provided.

The tension bars 16 and 17 are rotatably supported at the ends of the rotation supporting units 18 and 19. The base ends of the rotation supporting units 18 and 19 are supported by a support beam 113 provided to the support leg 11, enabling rotation around axial lines X18 and X19 along the main scanning direction.

In the support leg 11, the support beam 113 extends from the area between the leg part 112 and the case 24 in the front-rear direction (sub scanning direction) of the inkjet printing apparatus 1.

At a rear end portion of the support beam 113, a feed roller 12 is rotatably supported. At a front end portion of the support beam 113, a take-up roller 13 is rotatably supported. The feed roller 12 and the take-up roller 13 can rotate around axial lines X12 and X13 along the main scanning direction, respectively.

To the feed roller 12, a band-shaped medium M before printing is set. The medium M is supplied in a state of being wound around an outer periphery of a core material.

The medium M drawn from the feed roller 12 is wound around the tension bar 16, and then passes through the upstream supporting unit 35, the platen 31, and the downstream supporting unit 36 in order. After being wound by the tension bar 17, the medium M is wound around the core material set on the take-up roller 13.

The medium M is gripped between the grid roller 14 and the pinch roller 15. As the grid roller 14 rotates, the medium M gripped between the grid roller 14 and the pinch roller 15 is conveyed. The medium M is conveyed to one side in the sub scanning direction that is determined in accordance with the rotating direction of the grid roller 14.

In this process, the tension bars 16 and 17 apply tension to the medium M, and accordingly, the medium M is pressed against upper surfaces of the platen 31, the upstream supporting unit 35, and the downstream supporting unit 36. Thus, generation of creases and the like is prevented in an area of the medium M that exists below the carriage 22 (the area of the medium M to be printed).

The inkjet printing apparatus 1 according to the present embodiment is a printing apparatus that uses UV curable ink.

The UV curable ink printed on the medium M is solidified by irradiation with ultraviolet rays and is thereby fixed to the medium M.

Therefore, unlike another inkjet printing apparatus that uses water-based or solvent-based ink, a heater (heating unit) to volatilize the solvent to fix the ink is not necessary.

Here, irradiating an image, which is printed with UV curable ink, with ultraviolet rays results in the deep yellow color tone. It has been known that, subsequently, the color tone of the printed image changes over time and eventually settles to the target color tone, which is a so-called photobleaching phenomenon.

The time it takes for the yellowed color tone to settle to the target color tone depends on the type of ink and media, and ranges widely from several hours to several days.

The present inventor has made a diligent study with a view to shortening the time required for the yellowed color tone to settle down to the target color tone. As a result, it has been found that heating the UV curable ink after the ultraviolet ray irradiation can shorten the time required to settle the color tone compared to the case without heating.

In view of this, a heater 37, which is originally unnecessary in the printing apparatus that uses the UV curable ink, is provided on purpose to the inkjet printing apparatus 1. The UV curable ink after the ultraviolet ray irradiation is heated by the heater 37 downstream of the position irradiated with ultraviolet rays in the conveying direction of the medium M. Heating with the heater 37 is continued until the UV curable ink stops changing in hue.

This allows the yellow tint to be removed from the UV curable ink that has yellowed due to the ultraviolet ray irradiation, and the time required to settle the color tone becomes shorter than when the UV curable ink is not heated after the ultraviolet ray irradiation.

In this embodiment, the heater 37 is installed inside the downstream supporting unit 36.

In the case of (a) in FIG. 2, the heater 37 is installed downstream of the carriage 22 in the conveying direction (sub scanning direction) of the medium M in the inkjet printing apparatus 1. Therefore, the heater 37 heats the UV curable ink that is printed on the medium M after printing and that is after the ultraviolet ray irradiation.

In the case of (a) in FIG. 2, the heating is performed with a heater temperature of 35 to 70° C., and the length of the heater 37 in the conveying direction of the medium M is 300 to 400 mm, preferably 350 mm.

In the case of (a) in FIG. 2, the heater 37 directly heats the downstream supporting unit 36. The medium M placed on the downstream supporting unit 36 and the UV curable ink on the medium M are heated by the radiation heat.

Instead of the heater 37, a metal halide lamp (MH lamp) may be used to heat the UV curable ink after the ultraviolet ray irradiation.

Here, starting to heat the UV curable ink sooner after the ultraviolet ray irradiation to the UV curable ink can shorten the total time from printing to heating. Therefore, the heater 37 may be installed at a position directly below the area through which the carriage 22 moving in the main scanning direction passes (see a virtual line in the drawing).

In other words, it is only necessary the heater 37 is provided in the range that includes the position directly below the area through which the carriage 22 moving in the main scanning direction passes, as well as downstream of the position directly below the position in the conveying direction of the medium M during printing.

A warm air heater 38 may be placed above the downstream supporting unit 36 to heat the UV curable ink by blowing warm air to the UV curable ink on the medium M. In addition, a combination of the warm air heater 38 and the heater 37 may be used to heat the UV curable ink.

In other words, any heating unit that can heat the UV curable ink after the ultraviolet ray irradiation may be employed. Moreover, the location of the heating unit is not limited to only the location mentioned above.

Next, the change of the color tone of the UV curable ink after the ultraviolet ray irradiation and the stabilization of the color tone by heating are hereinafter described.

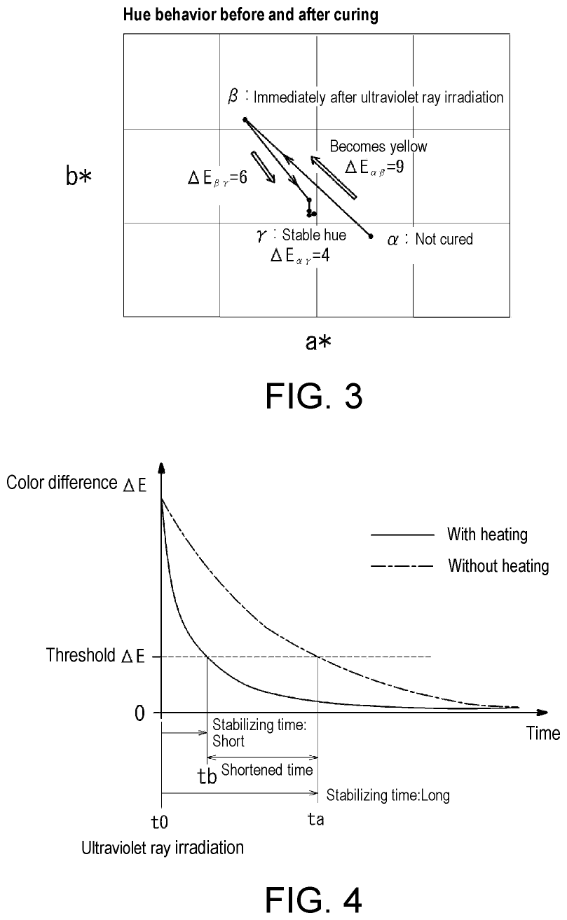

FIG. 3 is a diagram for describing the color difference behavior after the ultraviolet ray irradiation.

FIG. 4 is a diagram for describing the difference of the color difference behavior after the ultraviolet ray irradiation depending on the presence or absence of heating.

[Hue change]A base material (photo paper: PL-5000L) was coated with cyan-based UV curable ink (product name “LUS-120C”, manufactured by MIMAKI ENGINEERING CO., LTD.) using a bar coat (#6), and then irradiated with ultraviolet rays using a JFX-200 lamp.

The change over time in hue (L*a*b* value) before and after the ultraviolet ray irradiation was then checked using a colorimeter.

As illustrated in FIG. 3, irradiating the UV curable ink after the coating with ultraviolet rays changes the color tone of the UV curable ink into yellow (see signs α to β in the drawing). The yellow tint of the yellowed UV curable ink decreases over time, and finally the color tone becomes stable (see signs β to γ in the drawing).

In FIG. 3, the color difference (ΔE) before and after the ultraviolet ray irradiation is 9 (ΔEαβ=9), and the color difference (ΔE) until the yellow tint decreases and the color tone is stabilized and settled is 6 (ΔEβγ=6). This results in a color difference (ΔE) of 4 (ΔEαγ=4) between the color tone before the ultraviolet ray irradiation is performed and the color tone after the yellow tint is removed and the color tone is stabilized.

Thus, irradiating the UV curable ink with ultraviolet rays maximizes the color difference ΔE immediately after the irradiation. Thereafter, the value of color difference ΔE decreases over time, and finally, the color difference ΔE converges (see FIG. 4, single-dot chain line).

The present inventor has presumed from the change behavior of the color difference ΔE after the ultraviolet ray irradiation that the change behavior of the color difference as expressed in FIG. 4 is caused by the influence of a component that increases immediately after the ultraviolet ray irradiation and then decreases over time. Moreover, it has been presumed that the change of the color tone over time is due to the initiator contained in the UV curable ink.

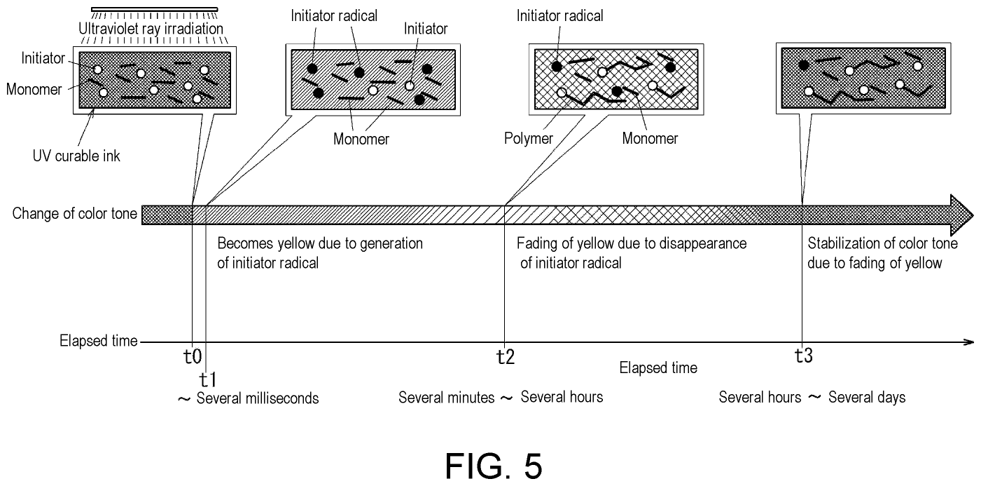

FIG. 5 is a diagram for presuming the change of the color tone over time due to the change of the initiator radicals over time.

The initiator is cleaved by the ultraviolet ray irradiation to generate the initiator radicals. The generated initiator radicals react with UV curable resin (monomers), causing the monomers to bond to each other sequentially and be polymerized, so that the UV curable ink is cured.

Since the initiator radicals are unstable, unreacted initiator radicals among the initiator radicals generated immediately after the ultraviolet rays decompose and volatilize over time.

The UV curable ink contains an excessive amount of initiators relative to the UV curable resin to ensure curing after the ultraviolet ray irradiation.

Therefore, at the time (time t1) immediately after the ultraviolet ray irradiation (time t0), a large amount of unreacted initiator radicals appear, and the unreacted initiator radicals that have appeared make the color yellow.

It is presumed that the yellow tint fades (time t1, time t2, and time t3) due to the consumption of the initiator radicals along with the progress of polymerization and the decrease of the initiator radicals due to decomposition over time, and finally the color tone is stabilized (after time t3).

Therefore, the present inventor has presumed that the color tone of the UV curable ink can be stabilized in a shorter time after the ultraviolet ray irradiation by promoting volatilization or decomposition of the unreacted disclosing agent radicals, for example. Then, to accelerate the decomposition and volatilization of the unreacted disclosing agent radicals, the present inventor considered heating the UV curable ink after the ultraviolet ray irradiation.

As a result, as illustrated in FIG. 4, it has been confirmed that heating the UV curable ink after the ultraviolet irradiation reduces the color difference ΔE (stabilizes and settles the color tone) in a shorter time than when heating is not performed.

The period from the time t0 of irradiation with ultraviolet rays until the color difference ΔE becomes less than or equal to the threshold color difference (threshold ΔE) at which it is determined that the color tone is stabilized and settled is shorter in the case with heating (tb−t0) than in the case without heating (ta−t0).

Here, the threshold color difference (threshold ΔE) is set to a value at which the color tone is almost indistinguishable visually when the hue is compared to the hue before the ultraviolet ray irradiation. The threshold color difference (threshold ΔE) is set to 3.0 in this embodiment. This threshold color difference (threshold ΔE) is not limited to this value only, and can be changed as appropriate depending on the required accuracy of the color tone.

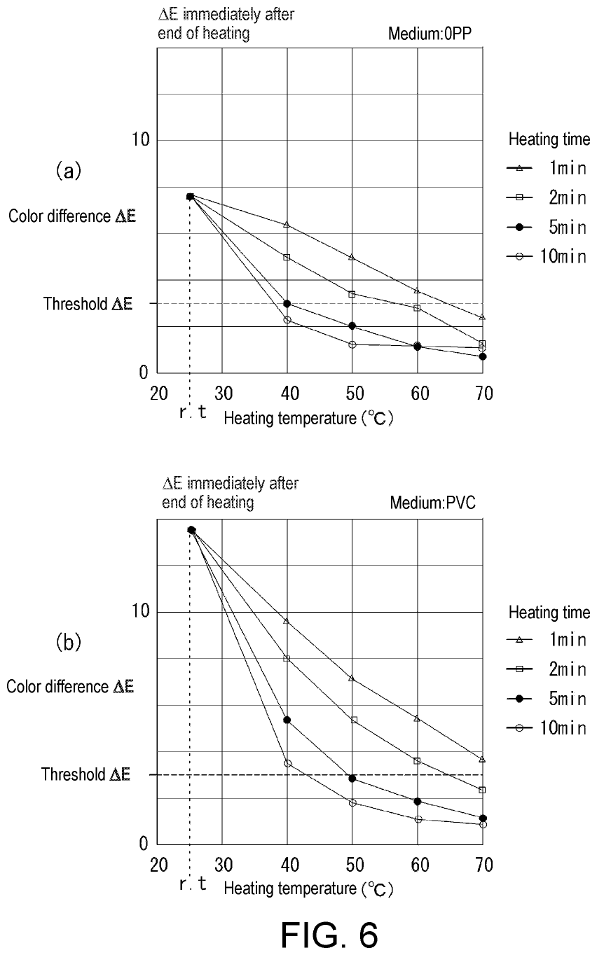

FIG. 6 is a diagram expressing the change over time of the color difference ΔE of the UV curable ink when printing and heating are performed using the inkjet printing apparatus (UCJV300) and the heater (JV300). The change over time of the color difference ΔE in FIG. 6 is the result in the case where the heater 37 is installed inside the downstream supporting unit 36 as described above.

Printing was performed in the inkjet printing apparatus (UCJV300) under the following conditions. Printing speed: 300×900 dpi at the fastest/12 Pass/Reciprocating printing.

In FIG. 6, (a) is a diagram expressing the relation between the presence or absence of heating and the heating time, and the color difference ΔE immediately after heating, and illustrates the case where oriented polypropylene (OPP, biaxially oriented polypropylene film) is used as the base material.

In FIG. 6, (b) is a diagram expressing the relation between the presence or absence of heating and the heating time, and the color difference ΔE immediately after heating, and illustrates the case where polyvinyl chloride (PVC) is used as the base material.

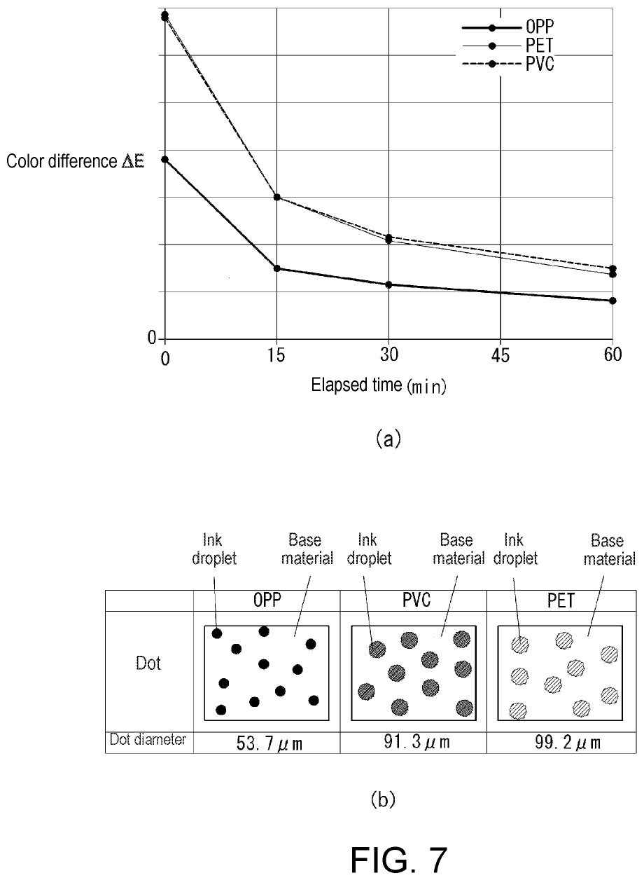

FIG. 7 is a diagram for describing the relation between the difference in medium (base material) and the color difference ΔE in the case without heating after the ultraviolet ray irradiation.

In FIG. 7, (a) is a diagram expressing the change over time of the color difference ΔE when solid printing is performed on different media (OPP, PVC, PET) using cyan-based UV curable ink (product name “LUS-120C”, manufactured by MIMAKI ENGINEERING CO., LTD.), the inkjet printing apparatus (UCJV300), and the heater (JV300).

In FIG. 7, (b) is a conceptual diagram for describing the difference in dot diameter when solid printing is performed on different media (OPP, PVC, PET).

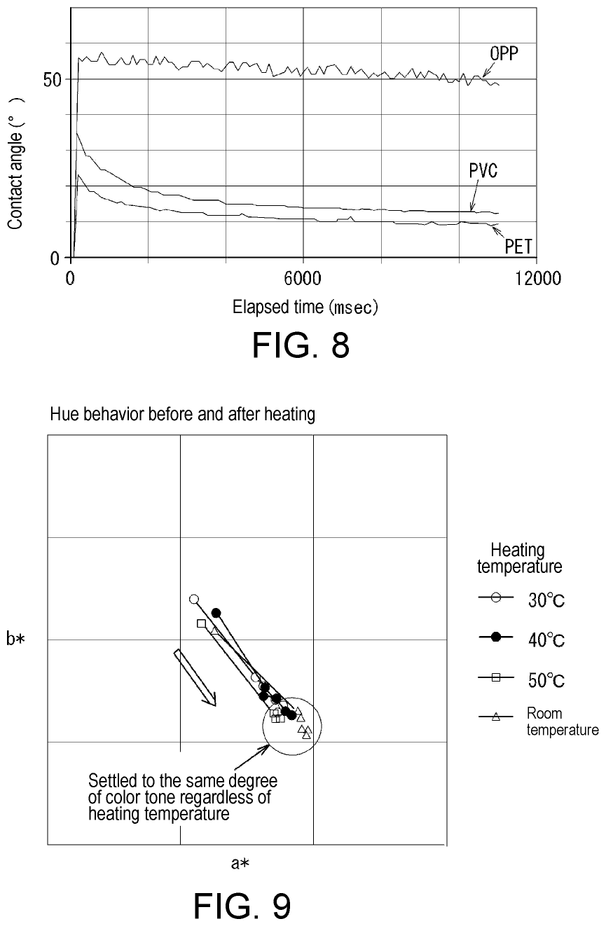

FIG. 8 is a diagram for describing the relation between the difference in medium (base material) and the contact angle of the UV curable ink. The contact angle was measured using the cyan-based UV curable ink (product name: LUS-120C, manufactured by MIMAKI ENGINEERING CO., LTD.) and a fully automatic contact angle meter (DM-701, manufactured by Kyowa Interface Science Co., Ltd) under the following conditions.

Syringe diameter: 18 G, Droplet volume: 1 μL, Measurement temperature: 25° C.

As expressed in (a) and (b) in FIG. 6, when comparing the color difference ΔE without heating (room temperature: r.t) and with heating (40° C., 50° C., 60° C., 70° C.), the higher heating temperature results in the smaller color difference ΔE immediately after heating.

Then, when comparing the color difference ΔE according to the heating time (1 min, 2 min, 5 min, 10 min), it has been confirmed that the longer heating time results in the smaller color difference ΔE immediately after heating.

In the case without heating, the color difference ΔE corresponds to the color differences at the elapsed time (1 min, 2 min, 5 min, 10 min) immediately after the ultraviolet ray irradiation, respectively.

When comparing the color difference ΔE according to the different media (base materials), it has been confirmed that OPP can reduce the color difference ΔE in a shorter heating time than PVC.

As expressed in FIG. 7, in the case without heating, OPP has the smaller color difference ΔE immediately after the ultraviolet ray irradiation than PVC or PET (polyethylene terephthalate).

In all cases of OPP, PVC, and PET, the color difference ΔE decreases and becomes stable as the time passes from the ultraviolet ray irradiation.

As expressed in (b) in FIG. 7, OPP has the smallest dot diameter (53.7 μm) on the printed matter immediately after the ultraviolet ray irradiation. The dot diameter of PVC (91.3 μm) and the dot diameter of PET (99.2 μm) are at substantially the same level.

As expressed in FIG. 8, OPP has lower wettability (larger contact angle) of the UV curable ink than PVC or PET, resulting in the smaller dot diameter of an ink droplet. Therefore, the proportion of the exposed surface of the base material in the printed matter is large.

Here, the yellowing of the UV curable ink changes depending on the amount of initiator radicals contained in the UV curable ink.

In the case of OPP, the dot diameter of the UV curable ink is smaller and the proportion of the exposed surface of the base material is larger. Therefore, even when yellowing occurs, the proportion of the ink area that has yellowed in the medium is smaller in OPP than in PVC or PET.

As a result, it is considered that since the yellowing degree of the printed image is suppressed, the color difference is smaller in OPP than in PVC or PET.

In other words, as the wettability of the UV curable ink on the medium (base material) is higher and the contact angle is smaller, the yellowing degree of the printed image immediately after the ultraviolet ray irradiation is higher.

As expressed in Table 1 below and FIG. 8, the contact angle of the UV curable ink on the medium is larger when the medium (base material) is OPP than when the medium is PVC or PET. Then, as a result of checking the change over time of the contact angle of the UV curable ink, it has been confirmed that the contact angle when the medium (base material) is OPP is retained without decreasing in a short time compared to when the medium is PVC or PET.

TABLE 1

| | | Contact angle (°) | | |
|---|---|---|---|---|
| | Elapsed time | 300 ms | 10000 ms | Retention (%) |
| Base material | OPP | 54.7 | 49.3 | 90.1 |
| | PVC | 32.1 | 12.6 | 39.3 |
| | PET | 21.0 | 9.6 | 45.7 |

In Table 1, 300 ms corresponds to the time after the ink droplet lands on the medium M and before the ultraviolet ray irradiation is performed. Moreover, 10000 ms corresponds to the time required for the change over time of the contact angle of the ink droplet that has landed on the medium M to settle down.

Here, “the change over time of the contact angle settles down” means the state in which the amount of change of the contact angle of the ink droplet per unit time becomes less than a threshold.

Therefore, based on the results in FIG. 7 and FIG. 8, even in the case of the media (base materials) with a small contact angle of the UV curable ink of less than 54.7°, heating the UV curable ink after the ultraviolet ray irradiation can settle the color tone of the image after the ultraviolet ray irradiation in a shorter time than in the case without heating.

Here, as expressed in FIG. 8, the ink droplet that lands on the medium M has different contact angles depending on the difference in material of the medium M (base material).

PVC has a smaller contact angle than OPP, and PET has an even smaller contact angle than PVC. The ink droplet with a smaller contact angle wets and spreads more easily after landing on the medium M. The ink droplet, which has spread and had larger dot gain, has a larger influence of photobleaching.

Therefore, in general-purpose printers that can use a variety of media, the heating conditions (temperature and total length) of the heater are designed to suppress the influence of photobleaching even when the fastest printing is performed using the medium with the small contact angle.

That is to say, the heating temperature by the heater 37 in (a) in FIG. 2 is 35 to 70° C., and the length in the conveying direction of the medium M is set to 300 to 400 mm. This is the setting for the size that can be reasonably integrated into the conveyance path of the general-purpose printer, in consideration of printing at the fastest or similar speed. This setting can suppress the color difference ΔE immediately after the heating by the heater to be less than or equal to the threshold, even under conditions that are severe to dryness.

The heating temperature and the length of the heater 37 are not particularly limited, and may be changed as appropriate as long as the color difference ΔE immediately after the heating by the heater can be suppressed to be less than or equal to the threshold.

FIG. 9 is a diagram expressing the relation between the presence or absence of the heating and the difference in heating temperature, and the change over time of the color difference ΔE.

As expressed in FIG. 9, a comparison of the case without heating (room temperature: r.t) and the case with heating (30° C., 40° C., 50° C.) indicates that the color tone eventually settles to the same hue regardless of whether heating is performed and regardless of the difference in heating temperature.

Thus, heating the UV curable ink after the ultraviolet ray irradiation does not cause a large difference in the final color tone. Then, heating the UV curable ink after the ultraviolet ray irradiation stabilizes the color tone of the printed image in a shorter time than in the case without heating.

For this reason, the present inventor provides the heater 37 (heating unit), which is originally unnecessary, in the inkjet printing apparatus 1 on purpose to heat the UV curable ink after the ultraviolet ray irradiation.

Thus, the color fixation of the UV curable ink can be settled down in a shorter time within the color difference range (less than threshold color difference) based on the target color tone, and the color tone can be stabilized.

As expressed in FIG. 6, in the case of OPP, heating at least at 40° C. for 5 minutes after the ultraviolet ray irradiation can make the color tone immediately after heating less than the threshold color difference (threshold ΔE). In the case of PVC, heating at least at 50° C. for 5 minutes after the ultraviolet ray irradiation can make the color tone immediately after heating less than the threshold color difference (threshold ΔE).

In light of the above, the inkjet printing apparatus 1 heats the UV curable ink at least at 35° C. after the ultraviolet ray irradiation, although this varies depending on the media. This allows the inkjet printing apparatus 1 to make the color tone less than the threshold color difference (threshold ΔE) in a shorter time than in the case of not heating the UV curable ink.

In the case of not heating the UV curable ink, it used to take several hours to several days to stabilize the color tone. By heating the UV curable ink, the inkjet printing apparatus 1 can reduce the time it takes to stabilize the color tone to be in the range of several minutes to several tens of minutes.

Therefore, in the inkjet printing apparatus 1 that uses the UV curable ink, the color tone of the image after the ultraviolet ray irradiation can be settled in a shorter time, so that the apparatus can meet the need of those who want to proofread printed matters as early as possible after printing.

As described above, the inkjet printing apparatus 1 in this embodiment has the following structure.

(1) The inkjet printing apparatus 1 includes: the ink-jet head 23 that ejects the UV curable ink to the medium M; the irradiation lamp 25 (ultraviolet ray irradiation unit) that irradiates the UV curable ink ejected to the medium M with ultraviolet rays; and the heater 37 (heating unit) that heats the UV curable ink after the ultraviolet ray irradiation by the irradiation lamp 25 and thereby stabilizes the color fixation of the UV curable ink.

The present inventor has found that when the UV curable ink is heated after the ultraviolet ray irradiation, the color tone of the printed image is settled to the target color tone in a very short time compared to the case without heating.

The UV curable ink is solidified by the ultraviolet ray irradiation and is thereby fixed to the medium M. Therefore, the inkjet printing apparatus 1 that uses the UV curable ink does not require a heater included in other inkjet printing apparatuses that use water-based or solvent-based ink.

By providing the heater 37 (heating unit), which is originally unnecessary, on purpose to heat the UV curable ink, the color fixation of the UV curable ink can be stabilized in a shorter time. Thus, the color tone of the image can be settled in a shorter time.

The inkjet printing apparatus 1 according to this embodiment has the following structure.

(2) The heater 37 is provided downstream of the position irradiated with ultraviolet rays in the conveying direction of the medium M.

The UV curable ink turns yellow immediately after the ultraviolet ray irradiation, resulting in a yellowish color tone, and thereafter the yellowish color decreases over time and the color settles to the original color. Therefore, heating before the ultraviolet ray irradiation does not contribute to stabilization of the color fixation.

With the structure as described above, the heater 37 is disposed at the position where the UV curable ink can be properly heated after the ultraviolet ray irradiation.

Thus, the position to place the heater 37 can be limited, so that the increase in manufacturing cost for the inkjet printing apparatus 1 due to the addition of the heater 37 can be suppressed.

Moreover, the dot gain of the ink droplet that lands on the medium is fixed by the ultraviolet ray irradiation and changes before the ultraviolet ray irradiation. Therefore, heating after the ultraviolet ray irradiation can reduce the influence on the dot gain, so that the improvement of the printing quality can be expected.

The inkjet printing apparatus 1 according to this embodiment has the following structure.

(3) The heater 37 (heating unit) heats the UV curable ink so that the UV curable ink stops changing in hue at a position downstream of the heater 37 in a conveying direction of the medium M and thereby stabilizes the color fixation of the UV curable ink.

The UV curable ink turns yellow immediately after the ultraviolet ray irradiation, resulting in a yellowish color tone. When the yellowed UV curable ink is heated, the yellowish color tone is reduced and the color tone settles to its original color in a shorter time than when heating is not performed.

Therefore, the heating time of the UV curable ink after the ultraviolet ray irradiation can be optimized by determining the end timing of heating by the heater 37 on the basis of the hue change of the UV curable ink after the ultraviolet ray irradiation. Furthermore, the color fixation of the UV curable ink can be stabilized at the downstream position immediately after heating by the heater 37, so that proofreading of printed matters, etc. can be performed at an early stage after printing.

The inkjet printing apparatus 1 according to this embodiment has the following structure.

(4) The lower limit of the heating temperature of the UV curable ink by the heater 37 after the ultraviolet ray irradiation is 35° C.

By setting the heating temperature by the heater 37 to 35° C. or higher, the UV curable ink after the ultraviolet ray irradiation can be heated until the UV curable ink stops changing in hue.

This makes it possible to integrate the heater 37 into the medium conveyance path of the existing printer apparatus without difficulty.

In other words, the UV curable ink after the ultraviolet ray irradiation can be heated until the UV curable ink stops changing in hue without the necessity of extending the conveyance path of the medium M in order to secure the time for heating of the UV curable ink after the ultraviolet ray irradiation. Therefore, there is no need to make the inkjet printing apparatus 1 particularly large.

As the heating temperature becomes lower, it takes longer for the color difference, which is the difference between the color fixation of the UV curable ink at the current time point and the target color fixation, to become below the target threshold color difference (threshold ΔE).

In the inkjet printing apparatus 1 according to the embodiment, the lower limit of the heating temperature is preferably 35° C., and more preferably 40° C. The inkjet printing apparatus 1 can sufficiently shorten the time until the color difference becomes less than the target color difference compared to the case without heating.

Thus, since the color fixation can be settled in a shorter time than in the case without heating, it is possible to meet the need of those who want to proofread printed matters as early as possible after printing.

The upper limit of the heating temperature is not limited in particular, but should be the temperature that is determined according to the heat resistance temperature of the medium to be printed, and that does not affect the characteristics of the medium or the characteristics of the printed image (strength, abrasion resistance, etc.).

This is because heating at temperatures that affect the characteristics of the medium may fail to satisfy the required performance of the printed matters.

The inkjet printing apparatus 1 according to this embodiment has the following structure.

(5) The medium M is a medium M that makes the contact angle of the UV curable ink less than 55° with respect to the medium M at the time of irradiation with ultraviolet rays by the irradiation lamp 25.

Even in the case of the medium with a contact angle of less than 55°, that is, the medium with the small contact angle of the UV curable ink that has landed thereon, heating the UV curable ink immediately after the ultraviolet ray irradiation can stabilize the color fixation of the UV curable ink in a shorter time and settle down the color tone of the printed image in a shorter time.

The medium M with a contact angle of UV curable ink of less than 55° has high wettability with the UV curable ink, resulting in a high degree of yellowish color tone of the printed image immediately after the ultraviolet ray irradiation.

In printing on such a medium M (base material), heating the UV curable ink immediately after the ultraviolet ray irradiation can stabilize the color fixation of the UV curable ink in a shorter time and settle the color tone of the printed image in a shorter time.

The inkjet printing apparatus 1 according to this embodiment has the following structure.

(6) The medium M used in the inkjet printing apparatus 1 is PVC or PET.

Even in the case of the medium with the small contact angle of the droplet of the UV curable ink, such as PVC or PET, the color fixation of the UV curable ink can be stabilized in a shorter time and the color tone of the printed image can be settled down in a shorter time.

The inkjet printing apparatus 1 according to this embodiment has the following structure.

(7) In the case of OPP, it is preferable that the lower limit of the heating temperature of the UV curable ink after the ultraviolet ray irradiation by the heater 37 is 40° C. and the lower limit of the heating time by the heater 37 is 5 minutes.

This structure allows control of the heating of the UV curable ink after the ultraviolet ray irradiation under optimal conditions for the medium. The inkjet printing apparatus 1 can reduce the color tone to be less than the threshold color difference (threshold ΔE) in a shorter time than when the UV curable ink is not heated.

In the example described in the above embodiment, the inkjet printing apparatus 1 prints on the medium rolled in a roll shape by a roll machine (vertical machine).

The present invention can also be suitably used for a flood-bed type inkjet printing apparatus that prints on a sheet-shaped medium placed on a table.

In this case, it is possible to heat the UV curable ink after the ultraviolet ray irradiation by installing a heater on the table or on the carriage, for example.

Although the embodiment of the present invention has been described above, the present invention is not limited only to the forms shown in the embodiments. Various changes are possible within the scope of the technical concept of the invention.

### DESCRIPTION OF REFERENCE SIGNS

1 Inkjet printing apparatus
11 Support leg
12 Feed roller
13 Take-up roller
14 Grid roller
15 Pinch roller
16, 17 Tension bar
18, 19 Rotation supporting unit
21 Guide rail
22 Carriage
23 Ink-jet head
24 Case
25 Irradiation lamp
31 Platen
34 Upstream supporting unit
36 Downstream supporting unit
37 Heater
38 Warm air heater
G Installation surface
M Medium
ΔE Color difference

1. An inkjet printing apparatus comprising:
an ink-jet head that ejects UV curable ink to a medium;
an ultraviolet ray irradiation unit that irradiates the UV curable ink ejected to the medium with ultraviolet rays; and
a heating unit that heats the UV curable ink after the ultraviolet ray irradiation by the ultraviolet ray irradiation unit and thereby stabilizes color fixation of the UV curable ink.

2. The inkjet printing apparatus according to claim 1, wherein the heating unit is provided downstream of a position irradiated with the ultraviolet rays in a conveying direction of the medium.

3. The inkjet printing apparatus according to claim 2, wherein the heating unit heats the UV curable ink so that the UV curable ink stops changing in hue at a position downstream of the heating unit in a conveying direction of the medium and thereby stabilizes the color fixation of the UV curable ink.

4. The inkjet printing apparatus according to claim 1, wherein a lower limit of heating temperature of the UV curable ink by the heating unit is 35° C.

5. The inkjet printing apparatus according to claim 1, wherein the medium is a medium that makes a contact angle of the UV curable ink less than 55° with respect to the medium at a time of irradiation with ultraviolet rays by the ultraviolet ray irradiation unit.

6. The inkjet printing apparatus according to claim 5, wherein the medium is PVC or PET.

7. The inkjet printing apparatus according to claim 2, wherein a lower limit of heating temperature of the UV curable ink by the heating unit is 35° C.

8. The inkjet printing apparatus according to claim 3, wherein a lower limit of heating temperature of the UV curable ink by the heating unit is 35° C.

9. The inkjet printing apparatus according to claim 2, wherein the medium is a medium that makes a contact angle of the UV curable ink less than 55° with respect to the medium at a time of irradiation with ultraviolet rays by the ultraviolet ray irradiation unit.

10. The inkjet printing apparatus according to claim 3, wherein the medium is a medium that makes a contact angle of the UV curable ink less than 550 with respect to the medium at a time of irradiation with ultraviolet rays by the ultraviolet ray irradiation unit.
